(19) United States
(12) Patent Application Publication
(10) Pub. No.: US 2023/0386285 A1
(43) Pub. Date: Nov. 30, 2023

(54) MATCHING RIGHTS SUCCESSION METHOD AND DEVICE SUPPORTING SAME

(71) Applicant: Hyongmo KIM, Gimje-si Jeollabuk-do (KR)

(72) Inventors: Hyongmo KIM, Gimje-si (KR); Jeongsang LEE, Jeonju-si (KR)

(21) Appl. No.: 18/031,908

(22) PCT Filed: Nov. 18, 2020
(86) PCT No.: PCT/KR2020/016222

§ 371 Date: Apr. 14, 2023

(30) Foreign Application Priority Data
Nov. 13, 2020 (KR) 10-2020-0151990

(51) Int. Cl. G07C 13/00; G06Q 50/18; G06Q 30/0283

(52) U.S. Cl. CPC G07C 13/00; G06Q 50/184; G06Q 30/0283; G06Q 2230/00

(57) ABSTRACT

The present invention provides a matching service provision server for supporting matching rights succession. The matching service provision server includes a communication interface forming a communication channel, and a processor, wherein the processor is configured to, for at least one specific person for whom a matching right has been established, collect information of at least one successor to succeed the matching right from successor terminals communicating based on the communication interface, transmit voting information to determine whether to succeed the at least one successor to the at least one specific person to at least one interested party terminal holding at least a portion of the matching right, and determine a match of the at least one successor to the at least one specific person based on a voting result of the at least one interested party terminal.

### BACKGROUND OF THE INVENTION

### 1. Field of the Invention

The present invention relates to the succession of matching rights, and provides a technique for supporting the succession of the right to meet with a specific person or to participate in an event related to the specific person or the right to apply for participation to another successor related to the specific person.

### 2. Description of Related Art

As capitalism matures, the expansion of commodity form has led to the commodification of intangible services and emotions, and as a result, the image of certain individuals has also been commodified as having socially necessary value. In this context, an image commodity refers to a specific individual's labor and image as collateral, with aspiring celebrities and newcomers positioned as potential products in the cultural industry. In the economy of commodities, a particular symbolic value attached to a product can generate a strong desire for consumption, leading to actual purchases.

At this time, the concept of changing the intangible value of a celebrity, which can be viewed as a classification of a specific person, into a product called a stock and matching appeared, and in this regard, the prior art Korean Public Patent No. 2007-0076600 (published on Jul. 25, 2007) and Korean Public Patent No. 2011-0110884 (published on Oct. 10, 2011), The prior art discloses a system for accepting subscriptions for public offerings of celebrity shares corresponding to celebrities, and a system for arranging a match between celebrities when an agency affiliated with a celebrity reaches the cost of arranging a celebrity and meets the conditions for arranging a celebrity.

On the other hand, the duration of the value of a person's matching rights may be limited due to the person's popularity or activity, health and longevity limitations, or termination of their contract with the company.

### SUMMARY OF THE INVENTION

The present invention provides a matching right succession method and an apparatus for supporting the same, which can prevent the matching right of a specific person subject to a securitization instrument from rapidly losing or declining in value due to the circumstances or environment of the specific person by enabling a successor related to or negotiated with the specific person to take over the matching right of the specific person.

However, the technical problem to be achieved by this embodiment is not limited to the technical problem described above, and other technical problems may exist.

As a technical means for achieving the above-described technical problem, according to an aspect of the present invention, a matching right succession method comprising: collecting, by a matching service providing server, at least one successor information to succeed the matching right for at least one specific person for whom the matching right is set; transmitting, by the matching service providing server, by a matching service providing server, voting information for determining whether to succeed the at least one successor to the at least one specific person to at least one interested party terminal holding at least a part of the matching right; determining, by the matching service providing server, a matching of the at least one successor to the at least one specific person according to a voting result of the at least one interested party terminal.

Here, the collecting information on the successor includes providing a specific person list to the successor terminal held by at least one successor candidate; and receiving, from the successor terminal, selection information for selecting at least one specific person from the specific person list and successor profile information of the successor terminal.

Further, the transmitting to the at least one interested party terminal may comprise transmitting to the at least one interested party terminal a list of successors to the matching rights of the at least one specific person.

In particular, the transmitting the list of successor to the at least one interested party terminal may comprise, upon receiving confirmation (retroactive approval) from the at least one interested party terminal, including in the list of successor the successor information corresponding to the confirmation; and transmitting to the at least one interested party terminal the list of successor including the successor information corresponding to the confirmation.

Here, the list of successors may include succession priority information of a plurality of successors to the at least one specific person.

Further, the determining may comprise: weighting the voting results differently, based on a percentage of matching rights held by the at least one interested party terminal; and matching at least one successor to the at least one specific person based on the differently weighted voting results.

The method may further comprise transmitting the matching results to the at least one interested party terminal and the at least one successor terminal. The method may further comprise invalidating the matching result if the vote of the at least one interested party terminal is below a specified percentage.

The collecting may further comprise performing if the trading volume of the person's matching rights is below a specified size, or if the price per share of the person's matching rights is below a specified value.

The determining a match may comprise matching one or more successors to the at least one specific person in a specified priority order.

A matching service providing server according to an embodiment of the present invention, comprising a communication interface forming a communication channel, a processor, wherein the processor, for at least one specific person for whom a matching right has been established, collects information of at least one successor to the matching right from successor terminals communicating based on the communication interface, transmits voting information to determine whether the at least one successor will succeed the at least one specific person to at least one interested party terminal holding at least a portion of the matching right, and is set to determine a matching of said at least one successor to the at least one specific person based on a voting result of the at least one interested party terminal.

### Advantageous Effects

According to the present invention, the present invention enables a suitable successor to take over a matching right in a situation where the value of the matching right is about to decrease or disappear rapidly due to the death, disappearance, retirement, hospitalization, illness, trading volume below the threshold of the matching right, etc., of the person for whom the matching right was established.

In addition, the present invention enables the setting of matching rights to be handled through a specific person and a successor to secure stability, maintain the value of matching rights as an asset, and expand the actual matching rights usage environment through the exercise of matching rights with a successor on behalf of a specific person, depending on the circumstances of the specific person.

### BRIEF DESCRIPTION OF THE DRAWINGS

FIG. 1 is a schematic configuration of an embodiment of a matching service provision system that supports the succession of securitized matching rights of the present invention.

FIG. 2 is a block diagram for illustrating a matching service provision server included in the system of FIG. 1.

FIG. 3 is a diagram illustrating the process of sending and receiving data to and from each of the configurations included in the matching service provision system of FIG. 1.

FIG. 4 is a diagram illustrating an example of an interest terminal operation method related to a matching right succession method according to an embodiment of the present invention.

FIG. 5 is a diagram illustrating one example of an operation method of a matching service provision server in connection with a matching right succession method according to an embodiment of the present invention.

FIG. 6 is a diagram illustrating another example of an operation method of a matching service provision server in connection with a matching right succession method according to an embodiment of the present invention.

FIG. 7 is a diagram illustrating one example of an operation method of a successor terminal in connection with a matching right succession method according to an embodiment of the present invention.

### DETAILED DESCRIPTION OF THE PREFERRED EMBODIMENT

Embodiments of the present invention are described in detail below with reference to the accompanying drawings to facilitate practice by one of ordinary skill in the art to which the present invention belongs. However, the invention may be implemented in many different forms and is not limited to the embodiments described herein. In order to clearly illustrate the present invention in the drawings, parts not pertinent to the description have been omitted, and like parts throughout the specification have been designated by like drawing symbols.

Throughout the specification, when a part is said to be “connected” to another part, this includes not only being “directly connected” but also being “electrically connected” with another element in between. Further, whenever any part is said to “include” any component, it is to be understood, unless specifically stated to the contrary, not to exclude any other component, but to be capable of further including any other component, and not to preclude the possibility of the presence or addition of one or more other features, numbers, steps, actions, components, parts, or combinations thereof.

As used throughout the specification, the terms “about,” “substantially,” and the like are used to mean at or near the numerical value when manufacturing and material tolerances inherent in the recited meaning are given, and are used to aid in the understanding of the invention and to prevent unscrupulous infringers from taking unfair advantage of the disclosure where precise or absolute numerical values are stated. As used throughout the specification of the present invention, the terms “steps” or “steps of” do not mean “steps for”.

As used herein, a “unit” includes a unit realized by hardware, a unit realized by software, and a unit realized by both. Furthermore, a unit may be realized using two or more hardware, or two or more units may be realized using one hardware.

Some of the actions or functions described herein as being performed by a terminal, apparatus, or device may instead be performed by a server associated with the terminal, apparatus, or device. Similarly, some of the actions or functions described as being performed by a server may also be performed by a terminal, apparatus, or device associated with that server.

In this specification, some of the operations or functions described as mapping or matching a terminal with a person may be interpreted to mean mapping or matching a terminal's unique number or a person's identifying information, which is the terminal's identifying information (identifying data).

Also, in the context of the present invention, a specific person may refer to a person who is the subject of a securitization.

A successor (or successor specific person) may mean a person who replaces a person who is the subject of an existing securitization.

In addition, an interested party may mean any person who affects or receives the rights and obligations of the (existing/successor) designated person and his/her rights and obligations, such as a person who have been delegated or succeeded to the rights and obligations of the existing specific person and their successors, an equity holder of a security, an operating entity providing related services, etc.

For the purposes of this invention, the terminals owned by the successors shall be referred to as successor terminals, the terminals owned by the interested parties shall be referred to as interested party terminals, and the terminals owned by specific persons shall be referred to as specific person terminals. However, the invention is not bound or limited by these terms.

With respect to the matching rights of the present invention, a terminal of a specific person who has applied for matching but who, depending on the circumstances, transfers the matching rights to another specific person may become a specific person's terminal, wherein the terminal owned by the person eligible for such transfer may become a successor terminal, and the terminal owned by the person holding the matching rights may become an interested party terminal.

The present invention will now be described in detail with reference to the accompanying drawings.

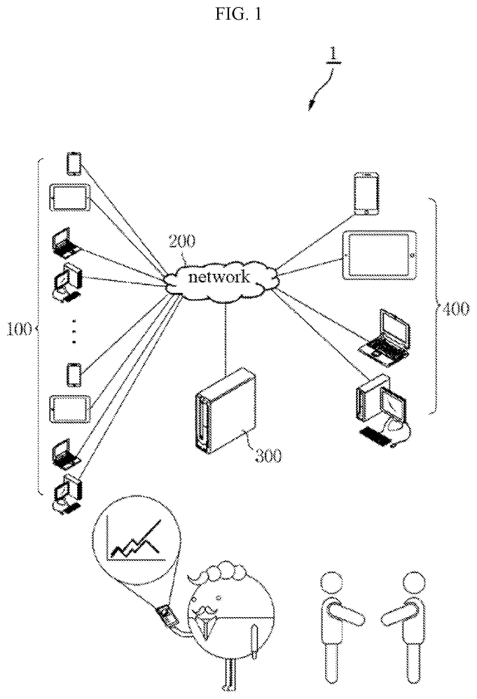

FIG. 1 is a schematic configuration of an embodiment of a matching service provision system that supports the succession of securitized matching rights of the present invention.

Referring to FIG. 1, first, the matching service provision system may support the establishment of matching rights for a specific person. The matching service provision system 1 based on buying and selling securitized matching rights (e.g., rights to participate in at least one event (e.g., meeting, fan meeting, traveling together, concert, photography together, etc.) related to a specific person) may include at least one interested party terminal 100 (or match request terminal), a matching service provision server 300, a specific person terminal 500 (or match application terminal), and a successor terminal 400. However, the matching service provision system 1 of FIG. 1, which supports the purchase and sale of securitized matching rights, the matching of holdings, and the succession service of the specific person terminal 500, is only one embodiment of the present invention, and the present invention should not be construed as limited by FIG. 1.

In this case, each component of FIG. 1 is generally connected via a network 200. For example, as illustrated in FIG. 1, the at least one interested party terminal 100 may be connected to a matching service provision server 300 via the network 200. And, the matching service provision server 300 may be connected to the at least one interested party terminal 100, the specified person terminal 500, and the successor terminal 400 via the network 200. Further, the successor terminal 400 may be connected to the matching service provider server 300 via the network 200.

As used herein, network 200 refers to a connectivity structure that enables information exchange between respective nodes, such as a plurality of terminals and servers, such as RF, 3rd Generation Partnership Project (3GPP) networks, Long Term Evolution (LTE) networks, 5th Generation Partnership Project (SGPP) networks, World Interoperability for Microwave Access (WIMAX) networks, the Internet, local area networks (LANs), wireless local area networks (Wireless LANs), wide area networks (WANs), personal area networks (PANs), Bluetooth networks, NFC networks, satellite broadcasting networks, analog broadcasting networks, and digital multimedia broadcasting (DMB) networks.

As used herein, the term at least one is defined to include the singular and plural, and it will be apparent that each component may exist in the singular or plural, and may refer to the singular or plural, even in the absence of the term at least one. Further, the number of components in the singular or plural may be changeable according to embodiments.

The at least one interested party terminal 100 may include a terminal of a requestor (e.g., a matching requestor who wishes to participate in an event related to a specific person (e.g., a meeting with a specific person, a fan meeting, an autograph signing, a concert, a trip together, a photo shoot together, etc.) using a web page, app page, program, or application related to the public offering and purchase and sale of securitized matching rights and a stake-based matching service.

Furthermore, the at least one interested party terminal 100 may be a terminal that holds a matching right of a specific person or successor of the person who wishes to meet and holds a certain percentage of the total number of matching rights. And, the at least one interested party terminal 100 may be a terminal that receives information such as a matching selection notification and a matching location from the matching service provision server 300 when it is selected as a matching target because its ranking is within a preset ranking as of a preset date. Conversely, the at least one interested party terminal 100 may be a device that receives a point corresponding to the price of a matching right corresponding to the public offering time, the purchase time, or the selection time from the matching service provision server 300 if it is not selected as a matching target because its ranking is outside the preset ranking as of the preset date.

The at least one interested party terminal 100 may receive an entry right (a certain number of entry rights) to participate in at least one event related to said specific person or successor from the matching service provision server 300 according to the share of matching rights owned. The interested party terminal 100 may, under user control, provide said entry rights to win a meeting with the specific person or successor. The drawing method of the entry rights may be a random method.

The interested party terminal 100 may have the opportunity to participate in at least one event related to a specific person or successor based on the percentage of matching rights held. Here, some of the plurality of events related to a specific person or successor may be available only to users with a certain shareholding percentage. Accordingly, an interested party terminal 100 with a higher ownership percentage may have the opportunity to participate in a wider variety of events, and the probability of participating in a particular event may be relatively higher based on the ownership percentage.

Here, the at least one interested party terminal 100 may be implemented as a computer capable of accessing a server or device at a remote location via a network. The computer may include, for example, a laptop, desktop, notebook, or laptop equipped with a navigation, web browser. In this case, the at least one interested party terminal 100 may be implemented as a terminal that can access a server or terminal at a remote location via a network. The at least one interested party terminal 100 may be, for example, a portable and mobile wireless communication device, such as a navigation, personal communication system (PCS), global system for mobile communications (GSM), personal digital cellular (PDC), personal handset system (PHS), personal digital assistant (PDA), International Mobile Telecommunication (IMT)-2000, Code Division Multiple Access (CDMA)-2000, W-Code Division Multiple Access (W-CDMA), Wireless Broadband Internet (Wibro) terminals, and all types of handheld-based wireless communication devices such as smartphones, smartpads, tablet PCs, etc.

In particular, the at least one interested party terminal 100 of the present invention may engage in setting a successor to a specific person. For example, the at least one interested party terminal 100 may receive a list of successors to a specific person provided by the matching service provision server 300 and provide selection information to the matching service provision server 300 to select a successor to take over the matching rights of the specific person. In this process, the at least one interested party terminal 100 may provide its identification information to the matching service provision server 300, which may enable the interested party terminal 100 to determine the percentage share of matching rights for the specific person. Alternatively, the interested party terminal party 100 may inform the matching service provider server 300 of the percentage of matching rights it holds. The percentage of matching rights held by the interested party terminal 100 may serve as a weighting factor in the process of selecting a successor.

In connection with supporting the functions described above, the interested party terminal 100 may include a terminal communication circuit, a terminal memory, a terminal display, a terminal input, and a terminal processor. The terminal communication circuit forms a communication channel with the matching service provision server 300, and the terminal memory may store matching right information, event information related to a specific person or successor, condition information for participation in each event, a list of specific persons, a list of successors, matching right share information, and the like. The terminal processor may connect to the matching service provision server 300 in response to a user control input through the terminal input, and may transmit an input signal to the matching service provision server 300 regarding the selection of a successor of a specific person through the matching service provision server 300. Alternatively, the terminal processor may support non-voting for a particular candidate among the successor candidates for a specific person, or may support voting for other successors not included in the successor candidates. In this process, the terminal display may output a list of persons, a list of successors, a selection of successors, a voting screen for determining succession, succession determination information, and the like.

The matching service provision server 300 may be a server that provides a matching service web page, app page, program, or application based on the purchase and sale of securitized matching rights. The matching service provision server 300 may receive and upload information, such as a profile, from the successor terminal 400 and conduct a public offering with respect to the users of the successor terminal 400 based on the at least one interested party terminal 100.

In particular, the matching service provision server 300 of the present invention is capable of transmitting and processing various data, calculating and determining a successor, and guiding a successor in order to establish a successor for a specific person. The above-described matching service provision server 300 may be implemented as a computer that can access a server or terminal at a remote location via a network. The computer may include, for example, a notebook, desktop, laptop, or the like equipped with a navigation, web browser.

The specific person terminal 500 may be a terminal owned by a specific person for whom a matching right has been established through a matching application. The successor terminal 400 may be a terminal of a successor applicant who wishes to succeed a specific person. The specific person may be, for example, but not limited to, an entertainer, celebrity, broadcaster, aspiring entertainer, author, athlete, religious figure, politician, journalist, etc. In addition, the successor applicant may be a person equivalent to any of the above.

To request succession to a specific person, the successor terminal 400 may provide his or her profile (e.g., physical information, age information, history information, hobbies or specialties, etc.) and necessary information to the matching service provision server 300, and receive a result from the matching service provision server 300 as to whether he or she can succeed to the specific person.

The successor terminal 400 (or successor candidate terminal) may support various services that the successor terminal 500 receives from the matching service provision server 300 when the succession to the specific person is determined.

For example, a successor with a successor terminal 400 may support the exercise of a matching right to be performed by a specific person (e.g., meeting). Further, the successor terminal 400 may be a terminal that receives a predetermined percentage of the amount paid at the at least one interested party terminal 100, similar to the specific person terminal 500. And, the successor terminal 400 may be a terminal that receives feedback from the matching service provision server 300 on the post-matching reviews from the at least one interested party terminal 100 when a succession to a specific person is determined.

Here, the successor terminal 400 or the specific person terminal 500 may be implemented as a computer capable of connecting to a server or terminal at a remote location over a network. The computer may include, for example, a laptop with a navigation, web browser, desktop, notebook, or the like. In this case, the successor terminal 400 may be implemented as a terminal that can access a server or device at a remote location over a network. The successor terminal 400 may be, for example, a portable and mobile wireless communication device, such as a navigation, personal communication system (PCS), global system for mobile communications (GSM), personal digital cellular (PDC), personal handset system (PHS), personal digital assistant (PDA), or international mobile telecommunication (IMT)-2000, CDMA (Code Division Multiple Access)-2000, W-CDMA (WCode Division Multiple Access), Wibro (Wireless Broadband Internet) terminals, and all kinds of handheld-based wireless communication devices such as smartphones, smartpads, tablet PCs, etc. From an electronic device perspective only, such a successor terminal 400 may be substantially identical to the interested party terminal 100.

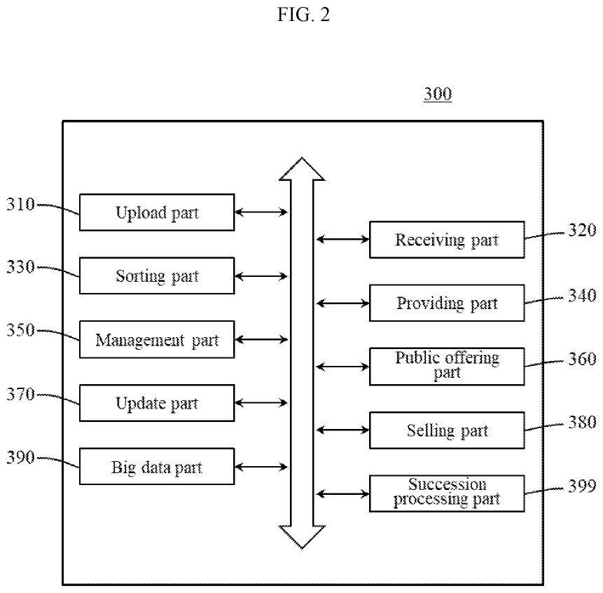

FIG. 2 is a block diagram for illustrating a matching service provision server included in the system of FIG. 1.

Referring to FIG. 2, the matching service provision server 300 may include a server communication circuit, a server memory, and a server processor. The server communication circuit may support a communication function of the matching service provision server 300, forming a communication channel with the interested party terminal 100, the specific person terminal 500, and the successor terminal 400. The server memory may store various programs or data related to the operation of the matching service provision server 300. The server processor may perform signal processing or data delivery related to the operation of the matching service provision server 300. For example, the server processors of the matching service provision server 300 may include an uploading part 310, a receiving part 320, a sorting part 330, a providing part 340, a management part 350, a public offering part 360, an updating part 370, a selling part 380, a big data part 390, and a succession processing part 399.

When the matching service provision server 300 according to one embodiment of the present invention, or another server (unidentified) operating in conjunction with it, transmits to the at least one interested party terminal 100, the specific person terminal 500, and the successor terminal 400 an application, program, app page, web page, etc. of a matching service based on the purchase and sale of securitized matching rights, the at least one interested party terminal 100, the specific person terminal 500, and the successor terminal 400 may install or open the application, program, app page, web page, etc. of a matching service based on the purchase and sale of securitized matching rights. Additionally, a service program may be executed on the at least one interested party terminal 100, specific person terminal 500, and successor terminal 400 using a script executed in a web browser.

As used herein, a web browser refers to a program that enables access to world wide web (WWW) services and receives and displays hypertext described in hypertext mark-up language (HTML), and includes, for example, Netscape, Explorer, chrome, and the like. Application also refers to an application on a device and includes, for example, an app running on a mobile device (e.g., a smartphone).

In the product market, the value of a specific person can be replaced by the logic of supply and demand, and the matching service provision server 300 of the present invention can guide the public offering price related to a specific person or a successor, issue securitized matching rights (e.g., the right to participate in an event (e.g., a meeting, a fan meeting, a concert, etc.) related to the specific person) in the form of shares based on the public offering price, and support the buying and selling of said shares among the interested party terminals 100. Accordingly, the matching service provision server 300 of the present invention supports the purchase and sale of matching rights at a generally higher price as the number of demanders who wish to purchase matching rights increases, and at a lower price as the number of demanders who wish to purchase matching rights decreases, thereby creating new value by commoditizing intangible services related to a specific person or successor, and fulfilling the desires of matching requesters based on this.

Referring to FIG. 2, the uploading part 310 may receive matching obligor data including a profile of a matching obligor (e.g., a specific person or a successor) from the specific person terminal 500 or the successor terminal 400 and upload it to the matching service provision page as a matching target list (e.g., a specific person list, a successor list).

The receiving part 320 may receive a purchase event from the at least one interested party terminal 100 to purchase a matching right of the specific person terminal 500 or the successor terminal 400. In this case, the price of one matching right may be set as a ratio of the total number of matching rights (the number of matching rights initially issued) to the total number of public offering points, for example, if 100 matching rights were issued for celebrity A, 100 matching rights were offered in a public offering, and the total public offering points were 200 points.

The sorting part 330 may store and update the received buying events as a history log, and may sort the at least one interest party terminal 100 based on the share of matching rights held by the matching applicant as of the preset matching date. Alternatively, the sorting part 330 may distribute a plurality of events with different meeting times or different types of events based on the percentage shareholding of the sorted match requesters. As used herein, a web browser refers to a program that enables access to world wide web (WWW) services and receives and displays hypertext described in hypertext mark-up language (HTML), and includes, for example, Netscape, Explorer, chrome, and the like. Application also refers to an application on a device and includes, for example, an app running on a mobile device (e.g., a smartphone). In the product market, the value of a specific person can be replaced by the logic of supply and demand, and the matching service provision server 300 of the present invention can guide the public offering price related to a specific person or a successor, issue securitized matching rights (e.g., the right to participate in an event (e.g., a meeting, a fan meeting, a concert, etc.) related to the specific person) in the form of shares based on the public offering price, and support the buying and selling of said shares among the interested party terminals 100. Accordingly, the matching service provision server 300 of the present invention supports the purchase and sale of matching rights at a generally higher price as the number of demanders who wish to purchase matching rights increases, and at a lower price as the number of demanders who wish to purchase matching rights decreases, thereby creating new value by commoditizing intangible services related to a specific person or successor, and fulfilling the desires of matching requesters based on this.

Accordingly, the providing part 340 may extract the at least one interest party terminal 100 corresponding to the preset ranking and provide a matching schedule with the matching obligor at the preset matching reference date.

The management part 350 may extract the at least one interest party terminal 100 corresponding to the preset ranking from the providing part 340, and after providing the matching schedule with the matching obligor on the preset matching reference date, convert the matching rights corresponding to the holding shares of the remaining interested party terminal 100 not included in the ranking into points corresponding to the matching rights and return them to the account of the remaining interested party terminal 100, or set the holding shares to be retained by the remaining interested part terminal 100.

The public offering part 360 may receive the matching obligor data including the profile of the matching obligor from the specific person terminal 500 or the successor terminal 400 from the uploading part 310, upload it to the matching service provision page as a matching target list, and proceed with the public offering to the specific person terminal 500 or the successor terminal 400 of the at least one interested party terminal 100 to determine the initial price of the matching rights.

The updating portion 370 may update the fluctuation of the price of the matching rights in real time based on the demand for the matching rights after receiving a purchase event from the at least one interested party terminal 100 from the receiving portion 320 to purchase the matching rights of the particular terminal 500 or successor terminal 400.

After receiving a buy event from the at least one interested party terminal 100 from the receiving part 320 to buy a matching right of a specific person terminal 500 or successor terminal 400, the selling part 380 may receive a sell event from the at least one interested party terminal 100 to sell a matching right of a successor terminal 400. Then, the selling part 380 may extract points, which are real-time prices of the matching rights of the matching applicant, to execute the sale of the received sell event, and may return the points to the account of the at least one interested party terminal 100.

The big data part 390 may receive the matching obligor data including the profile of the matching obligor from the upload department 310 from the specific person terminal 500 or the successor terminal 400, upload it to the matching service provision page as a matching target list, and collect information about the matching obligor using a web crawler to build a big data, deliver a query to the big data that analyzes the information of the matching obligor based on the preset parameters, output a response to the query, and increase or decrease the price of the initial matching right of the specific person terminal 500 or the successor terminal 400 based on the output response. The succession processing part 399 may process a connection for succession of the successor terminal 400 to the specific terminal 500. In this regard, the succession processing part 399 may recruit a list of successors who can inherit the matching rights of a specific person, and process the successor selected by the interested party terminals 100 with the matching rights of the specific person as the successor to the specific person. In this process, the succession processing part 399 may perform a valuation of the specific person and a valuation of the successor, and according to the difference, adjust the scope of exercise of the rights under the matching right by a certain percentage. For example, the succession processing part 399 may set a certain percentage (e.g., 2 times) or more of the rights generation or meeting time associated with meeting with the successor if the valuation of the specific person is 2 times greater than the valuation of the successor. The valuation may be determined by the activity status of the person or the successor over a period of time, or by a guarantee of the person or the successor, or the like. For example, the valuation may be determined by the number of works performed by a person over a specified period of time, the success of those works (e.g., the size of the proceeds), etc.

The succession processing part 399 may set up multiple successors for one specific person, or may set up one successor for multiple specific persons. The succession processing part 399 may adjust the succession time based on the consultation of the interested party terminal 100, the specified person terminal 500, and the successor terminal 400. For example, if a person is inactive for a specified period of time, the succession processing part 399 may allow a successor to take over the person's matching rights based on a set policy. Alternatively, if the person is active, the succession processing part 399 may reassign the inherited rights to the person if the time of inactivity is greater than or equal to the specified time according to the set policy, or may perform a succession split (e.g., split the fulfillment of the matching rights of the person and the successor) according to the agreement. The percentage of the succession split may be adjusted by the valuation at that time.

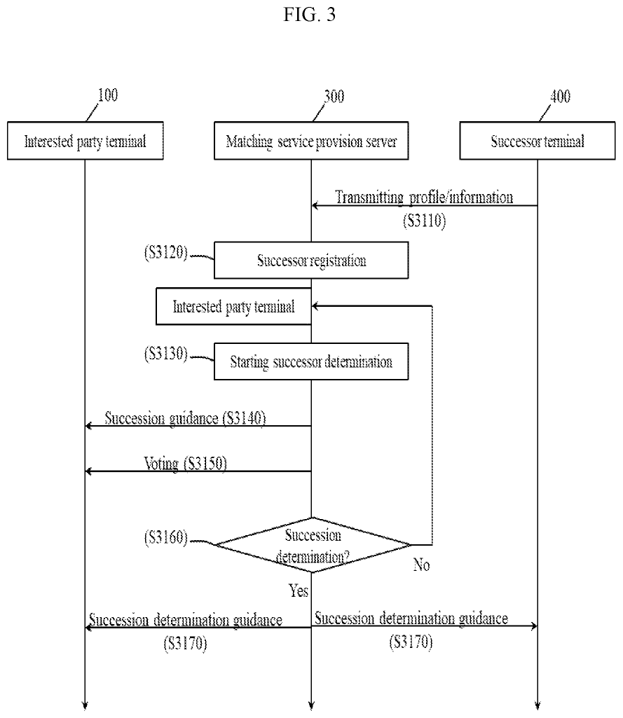

FIG. 3 is a diagram illustrating the process of sending and receiving data to and from each of the configurations included in the matching service provision system of FIG. 1.

Hereinafter, FIG. 3 describes one example of a process of transmitting and receiving data between each configuration, but this embodiment is not to be construed as a limitation of the present disclosure, and it is obvious to those skilled in the art that the process of transmitting and receiving data shown in FIG. 3 may be changed according to various embodiments described above. The following description is based on a situation in which a person is required to succeed to a successor under certain conditions. The specified conditions refer to the occurrence of one or more situations in which it is deemed inappropriate to continue trading, such as the death, disappearance, retirement, hospitalization, or illness of a person, a trading volume below or above a threshold, a trading value below or above a threshold, or the termination or destruction of a contract, and the above conditions may be exemplary rather than exhaustive. Alternatively, the establishment of a successor may be performed at the beginning of the establishment of a person's matching rights, and may be adjusted according to the circumstances of the person or the circumstances of the successor.

Referring to FIG. 3, the matching service provision server 300, in step S3110, when the successor terminal 400 transmits a profile and information, performs successor registration in step S3120, and starts succession determination in step S3130. For example, the matching service provision server 300 may start the succession determination when the person for whom the matching right is set meets certain conditions described above, or when the matching right of the person is initially created, or when a request from the successor occurs. Alternatively, the server 300 providing the matching service may initiate the succession determination when the price per share of a specific person's matching rights becomes a specified value or more, or when the trading volume of the matching rights is a specified trading volume or more.

Once the succession determination is initiated, in step S3140, the matching service providing server 300 provides succession guidance to the interested party terminal 100. The succession guidance may include providing the interested party terminal 100 with a specific person list including at least one specific person information and a successor list including at least one successor information. The successor list may include succession priority information for the at least one specific person. The succession priority information may include information that a successor having a first priority is set to succeed in priority upon satisfaction of certain conditions related to said person, and information that a successor having a next priority is set to succeed if said first successor satisfies specified conditions (including, for example, conditions under which said person succeeds in a situation where the first successor is unable to succeed).

In step S3150, the interested party terminal 100 may check the list received from the matching service provision server 300, select the at least one successor that it wants to map to the at least one specific person, and provide a selection value or a vote value to the matching service provision server 300. In the case of voting, it may be performed in the form of the matching service provision server 300 providing the list pre-mapped by the specific person terminal 500 and the successor terminal 400 to the interested party terminal 100, and the interested party terminal 100 selecting a preferred item from the list. In this process, the matching service provision server 300 may provide valuation value information for the person and the successor.

At step S3160, the matching service provision server 300 may check the voting values to determine a succession decision. If a succession decision has not been made, the following steps may be re-executed by branching back to before step S3130. Upon re-execution, the matching service provision server 300 may collect other successor information, or change the successor mapping relationship between a person and a successor, and provide it to the interested party terminal 100. Regarding the confirmation of the succession decision, the interested party terminal 100 may exercise a veto right to reject the succession between the person and the successor, in which case the succession proposed by the matching service provision server 300 may be rejected.

If the succession is determined, e.g., if the succession settings of the person and the successor proposed by the matching service provision server 300 are approved by the interested party terminal 100, in step S3170, the matching service provision server 300 may provide the succession determination guidance to the interested party terminal 100 and the successor terminal 400, respectively.

In the above-described succession determination process, the number of votes that the interested party terminal 100 can cast may vary depending on the number of shares of matching rights held by the interested party terminal 100 for a specific person. Then, the matching service provision server 300 may perform the succession setting for the person and the successor based on the majority of the voting results. Alternatively, the matching service provision server 300 may perform succession for a person based on a runoff vote and a majority of the votes cast. Alternatively, the matching service provision server 300 may determine the succession of a specific person and a successor based on a determination of the interested party terminal 100 of the largest shareholder with the highest percentage of matching rights for a specific person. Here, the matching service provision server 300 may perform the succession determination based on the consent of a right holder, such as a company of a specific person or a successor, and the interested party terminal 100, the successor terminal 400, and the specific person terminal 500 may be assigned non-voting or voting rights, i.e., each terminal may vote for a different specific person or a different successor, or may use its non-voting rights for the current proposed mapping to determine the succession. The matching service provision server 300 may determine that a successor designation for a specific person is valid upon a vote of a majority of the total shares of matching rights. The matching service provider server 300 may match one or more successor candidates for the at least one specific person in a specified priority order. The interested party terminal 100 may, in step S3150, check the list received from the matching service provider server 300, select the at least one successor that it wants to map to the at least one specific person, and provide a selection value or a vote value to the matching service provider server 300. In the case of voting, it may be performed in the form of the matching service provision server 300 providing the list pre-mapped by the specific person terminal 500 and the successor terminal 400 to the interested party terminal 100, and the interested party terminal 100 selecting a preferred item from the list. In this process, the matching service provision server 300 may provide valuation value information for the person and the successor.

At step S3160, the matching service provision server 300 may check the voting values to determine a succession decision. If a succession decision has not been made, the following steps may be re-executed by branching back to before step S3130. Upon re-execution, the matching service provision server 300 may collect other successor information, or change the successor mapping relationship between a person and a successor, and provide it to the interested party terminal 100. Regarding the confirmation of the succession decision, the interested party terminal 100 may exercise a veto right to reject the succession between the person and the successor, in which case the succession proposed by the matching service provision server 300 may be rejected.

Alternatively, the matching service provision server 300 may inform the interested party terminal 100 that a specific person has designated a successor, and process the succession decision based on the approval or disapproval of the interested party terminal 100. Alternatively, the matching service provision server 300 may enable a successor in interest (such as an heir) to designate a successor, and the designation of a successor may optionally result in an adjustment of the result based on a vote or approval of the interested party terminal 100. Alternatively, as previously mentioned, the matching service provision server 300 may specify the person-to-successor mapping, and optionally adjust the result based on the interested party terminal 100's vote or recommendation. Alternatively, when a right holder (such as an agency) designates a successor to a specific person, the matching service provision server 300 may inform the interested party terminal 100, and the succession decision may be adjusted based on the approval or disapproval of the interested party terminal 100. Alternatively, the matching service provision server 300 may announce information for voting by applying mutual weights among the interested party (the service operator, the successor to the rights of the specified person, the shareholder, and the specified person), and process the succession decision between the specified person and the successor according to the voting result.

In the above succession decision guidance, succession priority information for a specific person may be provided. For example, succession priority information for a plurality of successor candidates that can succeed a specific person in priority may be provided to the interested party terminal 100 and the successor terminal 400.

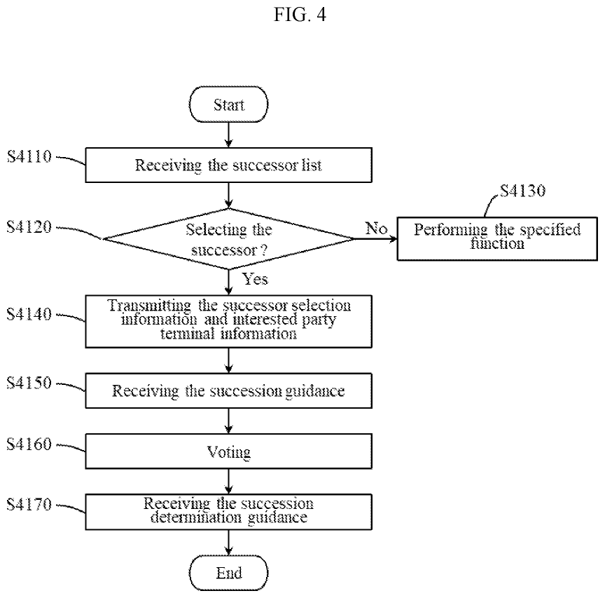

FIG. 4 is a diagram illustrating an example of an interest terminal operation method related to a matching right succession method according to an embodiment of the present invention.

Referring to FIG. 4, in step S4110, the interested party terminal 100 may receive a list of successors from the matching service provision server 300. In this regard, the interested party terminal 100 may connect to the matching service provision server 300 and receive a list of successors for a specific person provided by the matching service provision server 300.

At step S4120, said interested party terminal 100 may determine if user input for selecting a successor is received. If the user input is not for selecting a successor, the interested party terminal 100 may, in step S4130, process performing a specified function according to the user input. For example, the interested party terminal 100 may perform buying or selling matching rights, etc.

In step S4120, when a user input for selecting a successor occurs, the interested party terminal 100 may, in step S4140, provide the successor selection information and the information of the interested party terminal 100 to the matching service provision server 300. For example, the interested party terminal 100 may provide information about which successor has been selected by the interested party terminal 100 for a specific person, and information about the number of shares of matching rights held by the interested party terminal 100 for that specific person, or the percentage of shares held out of the total number of shares, to the matching service provision server 300.

At step S4150, said interested party terminal 100 may receive succession instructions from the matching service provision server 300. The succession guidance may include voting guidance information for the specific person and at least one successor mapped to the specific person. Upon receiving the succession instructions, the interested party terminal 100 may display a screen to enable the user to determine which successor is mapped to which specific person, and whether to approve the mapped specific person and the mapping person. After receiving the succession guidance, the interested party terminal 100 may, in step S4160, perform a vote based on the user input and provide the voting information to the matching service provision server 300. The matching service provision server 300 may collect the votes of the interested party terminals 100, perform statistical calculation processing to determine whether the succession decision of the specific person and the successor is valid, and if so, provide it to the interested party terminals 100.

Accordingly, in step S4170, the interested party terminal 100 may receive the succession decision guidance. The interested party terminal 100 may output the succession determination guidance information to a display or the like to enable the interested party terminal 100 to check the result of which successor is mapped to which specific person.

While the above description describes providing the information of the interested party terminal 100 to the matching service provision server 300 when transmitting the successor selection information, the present invention is not limited to this. For example, the provision of the information of the interested party terminal 100 may be performed in the voting process.

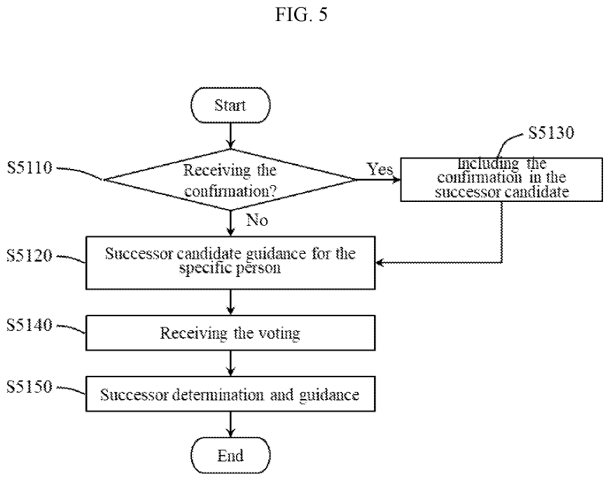

FIG. 5 is a diagram illustrating one example of an operation method of a matching service provision server in connection with a matching right succession method according to an embodiment of the present invention.

Referring to FIG. 5, in connection with the matching rights succession method of the present invention, in step S5110, the matching service provision server 300 may determine whether there is an authorization reception. The secondary reception may be received, for example, from the at least one interested party terminal 100, the specific person terminal 500. In connection with the endorsement reception, the matching service provision server 300 may provide a list of successors to the interested party terminal 100 and the specific person terminal 500. If there is no endorsement received in step S5110, in step S5120, the matching service provision server 300 may provide a list of candidate successors for the specific person.

If the endorsement is received in step S5110, in step S5130, the matching service provision server 300 may include the confirmation in the successor candidate, and in step S5120, the matching service provision server 300 may perform successor guidance for the specific person. For example, the matching service provision server 300 may provide mapping information including the specific person information and the successor information to the interested party terminal 100.

In step S5140, the matching service provision server 300 may receive votes from the interested party terminals 100. Further, in this operation, the matching service provision server 300 may receive identification information of the interested party terminals 100. The matching service provision server 300 may store and manage the number of stock holdings for a specific person that maps to the identification information of the interested party terminals 100. Based on this, the matching service provision server 300 may calculate a weighting for the votes of the particular interested party terminal 100 and derive a successor with the most votes allocated to the specific person overall.

If a successor to a specific person is derived according to the voting result, in step S5150, the matching service provision server 300 may perform a successor determination and guidance. In this process, the matching service provision server 300 may provide the successor determination to the interested party terminal 100 and the successor terminal 400. Alternatively, the matching service provision server 300 may provide information about the successor setting to the specific person terminal 500.

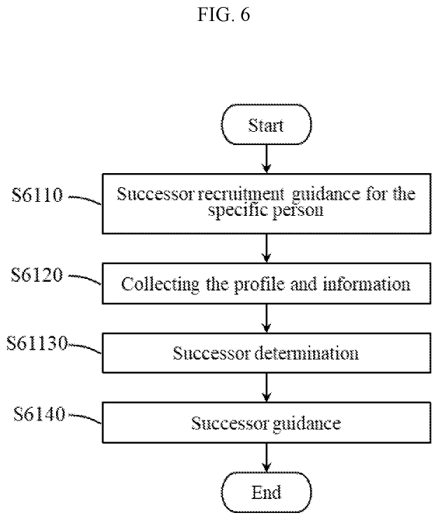

FIG. 6 is a diagram illustrating another example of an operation method of a matching service provision server in connection with a matching right succession method according to an embodiment of the present invention.

Referring to FIG. 6, in connection with the matching rights succession method, at step S6110, the matching service provision server 300 may perform successor recruitment guidance for a specific person. For example, the matching service provision server 300 may provide information related to successor recruitment to the at least one successor terminal 400 when certain conditions described above occur for a specific person. Alternatively, the matching service provision server 300 may provide information related to recruiting a successor to the at least one successor terminal 400 at the time of generating a matching right for the specific person. Alternatively, the matching service provision server 300 may provide information for recruiting successors to the successor terminal 400 based on changes in the circumstances of the individual, such as changes in the activity cycle or changes in the profitability of the work. The matching service provision server 300 may pre-store and manage contact information with the at least one successor terminal 400 for providing the successor recruitment information. The information related to recruiting a successor may include profile information for a specific person. The profile information about the person may include information about the person's activity history, age, current status, matching rights, obligations, returns from matching rights, and the like.

At step S6120, the matching service provision server 300 may collect profiles and information of successor candidates. The at least one successor terminal 400 that receives the successor recruitment announcement may provide the specific person profile information to the successor candidate. The successor candidate may view the specific person profile information and provide his or her profile and information to the matching service provision server 300 for application.

In step S6130, the matching service provision server 300 may perform a successor determination. In connection with the successor determination, the matching service provision server 300 may generate a list of successor terminals 400 that have participated in the successor recruitment announcement for the specific person, and may provide said list to the interested party terminal 100. The matching service provision server 300 may determine, by voting of the interested party terminals 100, the successor candidate that receives the most votes as the successor of the specific person.

Alternatively, the matching service provision server 300 may determine the at least one successor candidate that receives a specified percentage or more of the votes as the at least one successor to the specific person. In this behavior, the matching service provision server 300 may determine that a vote for determining a successor is a valid vote if the number of votes is greater than or equal to a specified percentage (e.g., 50%). If the number of votes is less than or equal to the specified percentage, information about the time of successor determination may be announced to the interested party terminals 100 again, and the successor determination process may be performed again at that time (e.g., providing a list of successor candidates and collecting votes).

Once the successor is determined, in step S6140, the matching service provision server 300 may perform successor guidance. The successor guidance information may include the person's profile information, the successor's profile information, and the succession ratio (the succession ratio contributes to the division of profits or fulfillment of obligations, such as meeting or participating in an event). Accordingly, the successor guidance information may be provided to the interested party terminal 100 and the successor terminal 400, respectively.

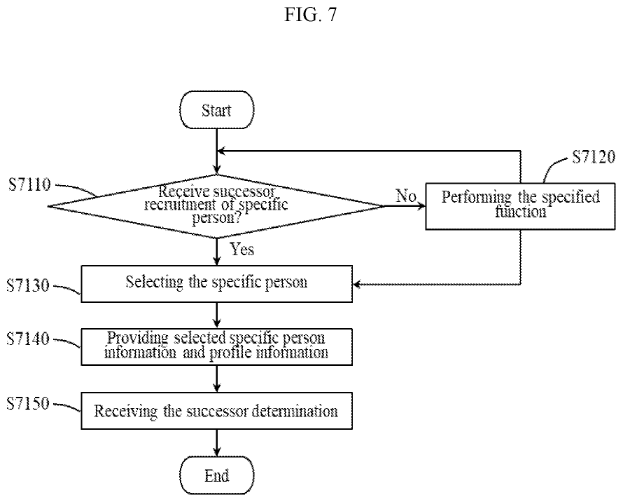

FIG. 7 is a diagram illustrating one example of an operation method of a successor terminal in connection with a matching right succession method according to an embodiment of the present invention.

Referring to FIG. 7, in connection with the matching right succession method of the present invention, in step S7110, the successor terminal 400 may, upon receiving a certain message, determine whether the message corresponds to a recruitment for a successor of a specific person. In this regard, the successor terminal 400 may determine whether the message includes an identifier of the matching service provision server 300. If the successor terminal 400 receives a message that includes an identifier of the matching service provision server 300, the successor terminal 400 may output the message differently from other general messages (e.g., messages sent by other user terminals). For example, the successor terminal 400 may process the message into a form having a specified color or shape and output it on a display, or output a specified alarm sound through a speaker.

If the received message is not related to recruiting a successor to a specific person, in step S7120, the successor terminal 400 may process performing a specified function. For example, the successor terminal 400 may output a specified alarm corresponding to the receipt of the generic message.

If said received message is a message related to recruiting a successor of a specific person, in step S7130, the successor terminal 400 may select a specific person. In this regard, said successor recruitment information of a specific person may include information of at least one specific person (e.g., profile information of a specific person). The successor terminal 400 may display the at least one specific person's information while outputting information related to the successor recruitment of the received specific person to a display. If a plurality of specific person information is included, the successor terminal 400 may output the specific person information in a list type or a multi-image type.

Upon receiving a user input to select a specific person via the display showing the at least one specific person information, in step S7140, said successor terminal 400 may provide the selected specific person information and profile information to the matching service provision server 300. In this regard, the successor terminal 400 may store and manage the profile information of the successor in memory. For the purpose of providing information, the successor terminal 400 may collect the address information or connection information of the matching service provision server 300 from the recruitment announcement provided by the matching service provision server 300, and transmit its own profile information and person selection information based on the address information or connection information. Upon receiving the person's selection and successor's profile information, the matching service provision server 300 may request a vote on the person's successor matching from the interested party terminal 100, as previously described in FIG. 4, and determine the person's successor matching based on the voting result.

In step S7150, said successor terminal 400 may receive a successor determination from the matching service provision server 300. Based on the successor determination, the information received from the matching service provision server 300 may include at least one of a succession point, a succession condition, and a succession ratio. The succession time specifies when a successor takes over a specific person's matching rights, and the succession time may be determined by the interested party terminal 100. For example, the succession point may be the same point in time as when a person's matching rights are established, a point in time when the trading volume of a person's matching rights is above or below a specified value, or a point in time when the price per share of a person's matching rights is above or below a specified value. Alternatively, the succession point may include one or more circumstances in which it is deemed inappropriate to continue the transaction, such as various conditions related to a person's health (e.g., death, disappearance, retirement, hospitalization, and illness), termination or destruction of the affiliation, etc.

The succession condition may include the transfer of a person's obligations (e.g., to meet a specified number of times or organize an event). The transfer of the obligation may result in an adjustment to the succession condition, such as a reduction or increase in the obligation, depending on the valuation of the person and the successor.

Alternatively, in the case of a successor to a person with matching rights, the matching rights may vest and be consolidated based on the ratio of the price per share of the person's matching rights at the time of the succession to the price per share of the successor's matching rights.

The successor percentage may mean the percentage of each successor to a specific person's matching right, if there are multiple successors. The succession ratio may be determined based on the valuation of the plurality of successors. The valuation may be determined by each successor's agency signing bonus, most recent guarantee, etc. If a single successor establishes succession to a plurality of persons, the percentage of succession may be determined based on the valuation of the plurality of persons.

On the other hand, the succession or re-succession of a person and his or her successors may be staggered. For example, if a specific person ceases to be active and a successor begins to be active, the matching rights of the specific person may succeed to the successor, and if the successor ceases to be active and the specific person reactivates, the specific person may receive a re-succession of matching rights from the successor.

If the successor terminal 400 fails to obtain a number of votes from the interested party terminals 100 above a specified percentage, the succession matching for the specific person may fail, in which case the successor terminal 400 may receive a message about the succession matching failure from the matching service provision server 300. Alternatively, the successor terminal 400 may receive a message from the matching service provision server 300 for adjusting at least one of the succession time, succession condition, and succession ratio.

As described above, with respect to a method of establishing a successor to a specific person according to an embodiment of the present invention, the present invention may include a method of recruiting candidates for a successor to replace a specific person when certain conditions with respect to the specific person are established, and matching the successor based on the approval of the interested party terminal 100.

Further, the matching right succession method of the present invention may include the steps of pre-designating one or more successor candidates prior to the establishment of said certain conditions, and assigning a succession ranking among the successor candidates.

Further, the matching rights succession method may determine a weight (e.g., a weight based on a matching rights holding status) of an interested party terminal in selecting a successor, and apply the weight to a voting result to select a successor. In this case, the weight ratio of each interested party terminal 100 may be 0% to 100%, respectively.

In selecting a successor, the above matching rights succession method may be configured to allow one or more interested party terminals 100 to select one or more successors, and may optionally support the interested party terminals 100 to select or approve the successor by voting. In the case of nomination, a weighted percentage (e.g., respectively) may be applied to the vote of each interested party terminal 100. Meanwhile, among the terms described in the present invention, substitution may be called differently by expressions such as transmission and succession, handover and takeover, etc.

The foregoing description of the invention is for illustrative purposes only, and one having ordinary knowledge in the technical field to which the invention belongs will understand that it can be readily adapted to other specific forms without changing the technical idea or essential features of the invention. It should therefore be understood that the embodiments described above are exemplary and non-limiting in all respects. For example, each of the components described in a single form may also be implemented in a distributed form, and similarly, components described as distributed may also be implemented in a combined form.

The scope of the invention is indicated by the following patent claims rather than by the detailed description above, and should be construed to include the meaning and scope of the claims and all modifications or variations derived from the equivalents thereof.

What is claimed is:

1. A matching rights succession method comprising:
collecting, a matching service provision server, information of at least one successor to succeed said at least one specific person for whom a matching right has been established;
transmitting, the matching service provision server, voting information to at least one interest terminal holding at least a portion of said matching rights to determine whether said at least one successor succeeds to the at least one specific person; and
determining, the matching service provision server, a match of the at least one successor to the at least one specific person, based on a voting result of said at least one interested party terminal.

2. The matching rights succession method of claim 1, wherein the collecting of the information of the at least one successor comprises:
providing a list of specific persons to a successor terminal held by at least one successor candidate; and
receiving from the successor terminal, selection information for selecting at least one specific person from the list of specific persons and successor profile information for the successor terminal.

3. The matching rights succession method of claim 1, wherein the transmitting to the at least one interested party terminal comprises transmitting to the at least one interested party terminal a list of successors to the matching rights of the at least one specific person.

4. The matching rights succession method of claim 3, wherein the transmitting the list of successors to the at least one interested party terminal comprises, upon receiving a confirmation (retroactive approval) from the at least one interested party terminal, transmitting to the at least one interested party terminal a list of successors including the list of successors information corresponding to the confirmation and including in the list of successors information corresponding to the confirmation.

5. The matching rights succession method of claim 3, wherein the list of successors includes succession priority order information for the plurality of successors to at least one specific person.

6. The matching rights succession method of claim 1, wherein the determining comprises:
applying a different weight to the voting result according to a holding ratio of a matching right possessed by the at least one interested party terminal; and
matching at least one successor to the at least one specific person according to the differently weighted voting result.

7. The matching rights succession method of claim 1, further comprising transmitting the matching results to the at least one interested party terminal and the at least one successor terminal.

8. The matching rights succession method of claim 1, further comprising invalidating said matching result if the vote of the at least one interested party terminal is below a specified percentage.

9. The matching rights succession method of claim 1, wherein the collecting comprises performing if the trading volume of the person's matching rights is less than a specified size, or if the price per share of the person's matching rights is less than a specified value.

10. The matching rights succession method of claim 1, wherein the determining comprises matching one or more successors to the at least one specific person in a specified priority order.

11. A matching service provision server for supporting matching rights succession, comprising:
a communication interface forming a communication channel, and a processor,
wherein the processor is configured to:
for at least one specific person for whom a matching right has been established, collect information of at least one successor to succeed the matching right from successor terminals communicating based on the communication interface;
transmit voting information to determine whether to succeed the at least one successor to the at least one specific person to at least one interested party terminal holding at least a portion of the matching right; and
determine a match of the at least one successor to the at least one specific person based on a voting result of the at least one interested party terminal.
